(19) United States
(12) Patent Application Publication
(10) Pub. No.: US 2019/0291595 A1
(43) Pub. Date: Sep. 26, 2019

(54) MODULAR AUTOMOTIVE MICROTURBINE SYSTEM

(71) Applicant: HK Battery Technology Inc., Pasadena, CA (US)

(72) Inventors: Bo Ruan, Pasadena, CA (US); Junhua Chen, Pasadena, CA (US); Robert McKeirnan, Pasadena, CA (US); Artur Bagumyan, Pasadena, CA (US); Tom Arnold, Pasadena, CA (US); Chuantao Wang, Pasadena, CA (US)

(21) Appl. No.: 16/365,042

(22) Filed: Mar. 26, 2019

Related U.S. Application Data
(63) Continuation-in-part of application No. 16/358,958, filed on Mar. 20, 2019.
(60) Provisional application No. 62/648,217, filed on Mar. 26, 2018.
(60) Provisional application No. 62/645,555, filed on Mar. 20, 2018.
(60) Provisional application No. 62/645,516, filed on Mar. 20, 2018.
(60) Provisional application No. 62/645,614, filed on Mar. 20, 2018.
(60) Provisional application No. 62/645,643, filed on Mar. 20, 2018.

(51) Int. Cl. B60L 50/61; F02C 6/20; F01D 15/10; B60K 6/00

(52) U.S. Cl. CPC B60L 50/61; F02C 6/20; B60L 50/10; B60K 6/00; F01D 15/10

(57) ABSTRACT

In an aspect of the disclosure, a method, a computer-readable medium, and an apparatus are provided. The apparatus may be a vehicle power system, which includes an electric motor, a secondary power source that energizes the electric motor, wherein the secondary power source employs a turbine to generate electricity, a second power source that supplements the primary power source to energize the electric motor, and a control component that monitors power provided to the electric motor by the primary power source, that determines that additional power needs to be provided to the electric motor in order to meet a driving requirement, and that directs additional power from the second power source to the electric motor.

### CROSS-REFERENCE TO RELATED APPLICATION(S)

This application claims the benefits of U.S. Provisional Application Ser. No. 62/648,217, entitled “AUTOMOTIVE MICRO TURBINE” and filed on Mar. 26, 2018, which is expressly incorporated by reference herein in its entirety. This application is also a continuation-in-part of U.S. patent application Ser. No. 16/358,958, entitled “MOBILE ELECTRICITY-GENERATOR SYSTEM ON VEHICLES” and filed on Mar. 20, 2019, which claims the benefits of U.S. Provisional Application Ser. No. 62/645,555, entitled “DISTRIBUTED, MOBILE ELECTRICITY-GENERATOR SYSTEM UTILIZING ELECTRIC VEHICLES” and filed on Mar. 20, 2018, U.S. Provisional Application Ser. No. 62/645,516, entitled “MICRO TURBINE AS A PRIMARY POWER FOR HYBRID ELECTRIC VEHICLE” and filed on Mar. 20, 2018, U.S. Provisional Application Ser. No. 62/645,614, entitled “MICRO GAS TURBINE VEHICLE RANGE EXTENDER” and filed on Mar. 20, 2018, U.S. Provisional Application Ser. No. 62/645,643, entitled “ACTIVE CONTROLS OF MICRO TURBINE FOR OPTIMAL PERFORMANCE” and filed on Mar. 20, 2018, all of which are expressly incorporated by reference herein in their entirety.

### BACKGROUND

### Field

The present disclosure relates to mobile electricity-generator system on vehicles.

### Background

The statements in this section merely provide background information related to the present disclosure and may not constitute prior art.

An Electric Range Extended Vehicle (EREV) is a type of vehicle that combines an internal micro turbine generator system combined with a battery pack and an electric propulsion system (e.g., an electric vehicle drivetrain). Electric Vehicles (EVs) use electric energy stored in battery packs to power the automobile. Nonetheless, EVs have travel range, maintenance, and life duration constraints. Therefore, there is an alternate approach by integrating a micro turbine generator system into EVs thus augmenting an EV into an Electric Range Extended Vehicle (EREV).

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, the present disclosure relates to a vehicle system having an engine. The engine includes a micro turbine generator configured to convert an output power from the micro turbine generator to a first alternative current power (AC), a fuel system connected to the engine and providing fuel or gaseous supply to the engine, and a rectifier connected to an outlet of the generator and configured to rectify the first AC power to a direct current (DC) power.

The system further includes an inverter connected to an outlet of the rectifier and configured to transform the DC power to a second AC power that can be subsequently applied to an electric motor of the EREV, a battery connected to the outlet of the rectifier, disposed between the rectifier and the inverter and being chargeable by an output of the rectifier, and a vehicle control module that controls the system to provide the second AC power from the micro turbine and/or the battery as power sources through the inverter for the electric motor of the hybrid vehicle.

Further, the EREV has an on-board battery for energy storage and an on-board micro turbine for power generation. The battery and micro turbine operate as an integrated system and can also provide vehicle to grid power. Certain implementations provide vehicle to grid power application via micro turbine range extender technology with low emission. Certain implementations can provide vehicle to vehicle grid network to support local high energy demand or during natural disaster. Certain implementations can provide local power demand in off-grid and rural area without easy access to local utility. Certain implementations can provide alternative clean power source based on local fuel availability due to system's fuel flexibility with a micro turbine generator.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The accompanying drawings illustrate one or more configurations of the present disclosure and together with the written description, serve to explain the principles of the present disclosure. Wherever possible, the same reference numbers are used throughout the drawings to refer to the same or like elements of a configuration.

FIG. 1 is a schematic diagram illustrating a power system of an EREV.

FIG. 2 is a schematic diagram illustrating a vehicle control module of an EREV.

FIG. 3 is a schematic diagram of the engine of FIG. 1.

FIG. 4 is a sectional view of a micro turbine system.

FIG. 5 is another sectional view of the micro turbine system.

FIG. 6 shows a comparison of electrical efficiency of a conventional EREV not employing a micro turbine system and two exemplary EREVs employing the micro turbine system.

FIG. 7 is a flow chart illustrating operation procedures of an EREV.

FIG. 8 is a diagram illustrating another micro turbine system.

FIG. 9 is a diagram illustrating the micro turbine module.

FIG. 10 is a diagram illustrating a vehicle chassis incorporating the micro turbine system.

### DETAILED DESCRIPTION OF THE PRESENT DISCLOSURE

The present disclosure is more particularly described in the following examples that are intended as illustrative only since numerous modifications and variations therein will be apparent to those skilled in the art. Various configurations of the present disclosure are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The terms “chip” or “computer chip”, as used herein, generally refer to a hardware electronic component, and may refer to or include a small electronic circuit unit, also known as an integrated circuit (IC), or a combination of electronic circuits or ICs.

Certain aspects of the present disclosure relate to computer control systems. As depicted in the drawings, computer components may include physical hardware components, which are shown as solid line blocks, and virtual software components, which are shown as dashed line blocks. One of ordinary skill in the art would appreciate that, unless otherwise indicated, these computer components may be implemented in, but not limited to, the forms of software, firmware or hardware components, or a combination thereof.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Micro turbines evolved from automotive and truck turbochargers, auxiliary power units for airplanes and small jet engines. Micro turbines offer a number of potential advantages compared to other technologies for small-scale power generation. These advantages include fewer number of moving parts, compact size, light-weight, greater efficiency, lower emissions, lower electricity costs and opportunities to utilize waste fuels. Micro turbines have the potential to be located on sites with space limitations for production of power. Waste heat recovery can be used with these systems to achieve efficiencies greater than 80 percent.

Micro turbines can be configured as either as a simple cycle or recuperated architecture. In a simple cycle, or non-recuperated, turbine inlet compressed air is mixed with fuel and burned under constant pressure conditions, resulting in a hot gas that is allowed to expand through a turbine wheel to perform work. After the work is performed, the hot gas is converted into waste heat and exhausted to the atmosphere. Simple cycle micro turbines may have lower direct material costs but provide a higher waste heat temperature that can be utilized more effectively for cogeneration applications versus recuperated units. Recuperated units use a primary surface or secondary primary surface counter flow heat exchanger that recovers the waste heat from the exhaust stream and transfers heat it to the turbine inlet compressed air stream. The preheated turbine inlet compressed air is then used in the combustion process. If the air is preheated, less fuel is necessary to raise its temperature to the required turbine inlet temperature. Recuperated units have an overall higher thermal efficiency than non-recuperated units that result in 30-40 percent fuel savings. Advanced materials, such as ceramics, high temperature alloys, thermal barrier coatings, and additive manufacturing methods are some of the key enabling technologies to further improve micro turbines efficiency gains which allow for significant increase in engine operating temperatures.

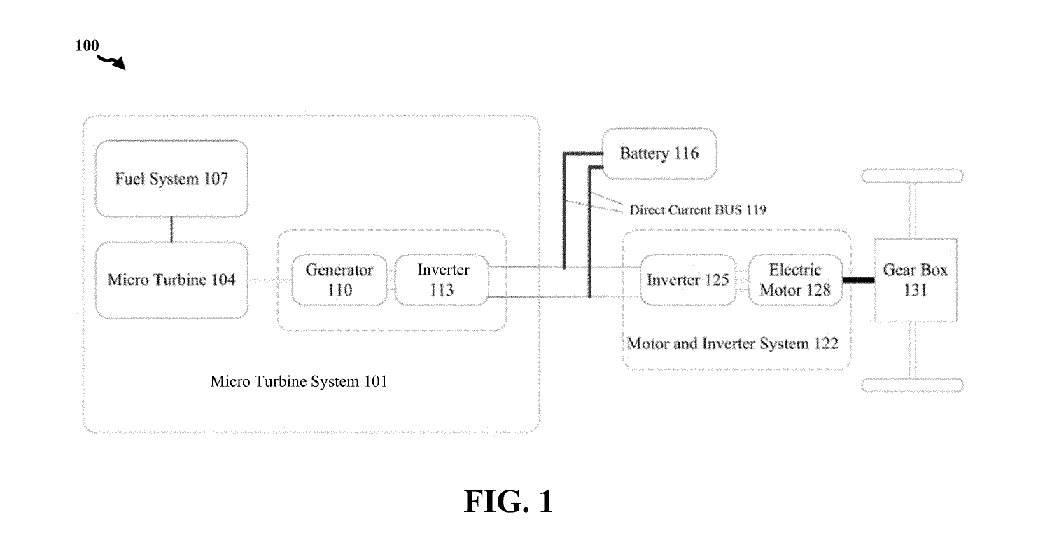

FIG. 1 is a schematic diagram illustrating a power system of an EREV. A power system 100 includes a micro turbine system 101, a motor and inverter system 122 with an inlet connected to micro turbine system 101 and an outlet connected to a gear box 131 of the hybrid vehicle, and a battery 116 disposed between micro turbine system 101 and motor and inverter system 122.

The micro turbine system 101 includes a micro turbine 104, a generator 110 connected to micro turbine 104, a fuel system 107 providing fuel or gaseous supply to the micro turbine 104, and an inverter 113 connected to an outlet of generator 110 and rectifying generator 110 AC power to a Direct Current (DC) power. Also, this inverter 113 will be used to converter DC power to AC to the generator 110 for motoring or starting the micro turbine 104.

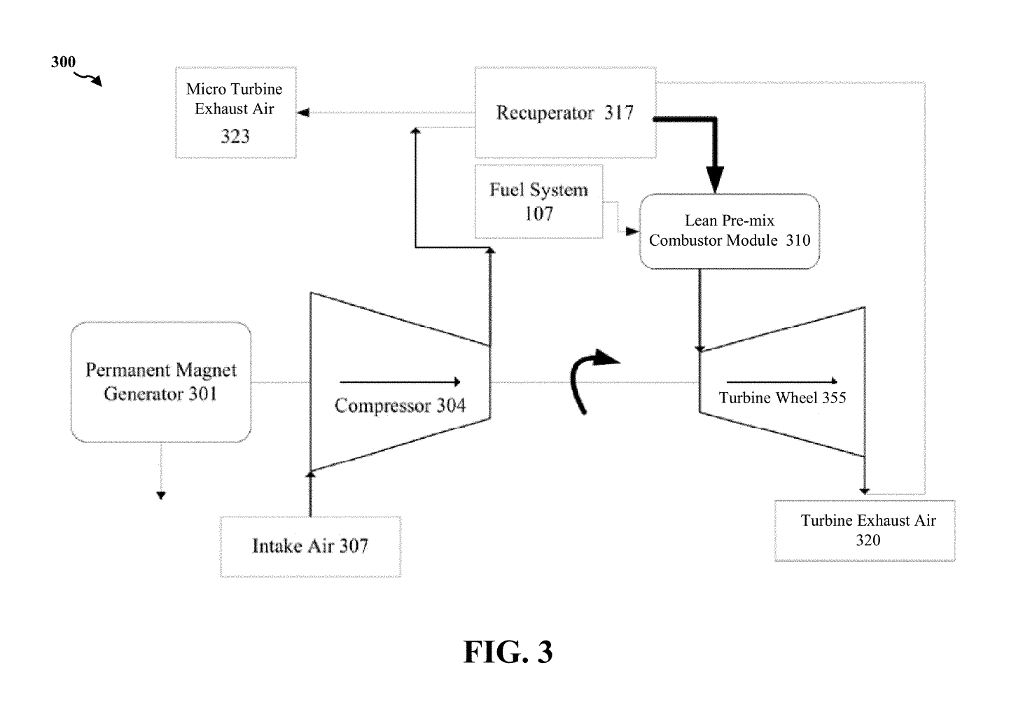

The micro turbine system 101 and generator 110 are further described in FIG. 3 of the present disclosure.

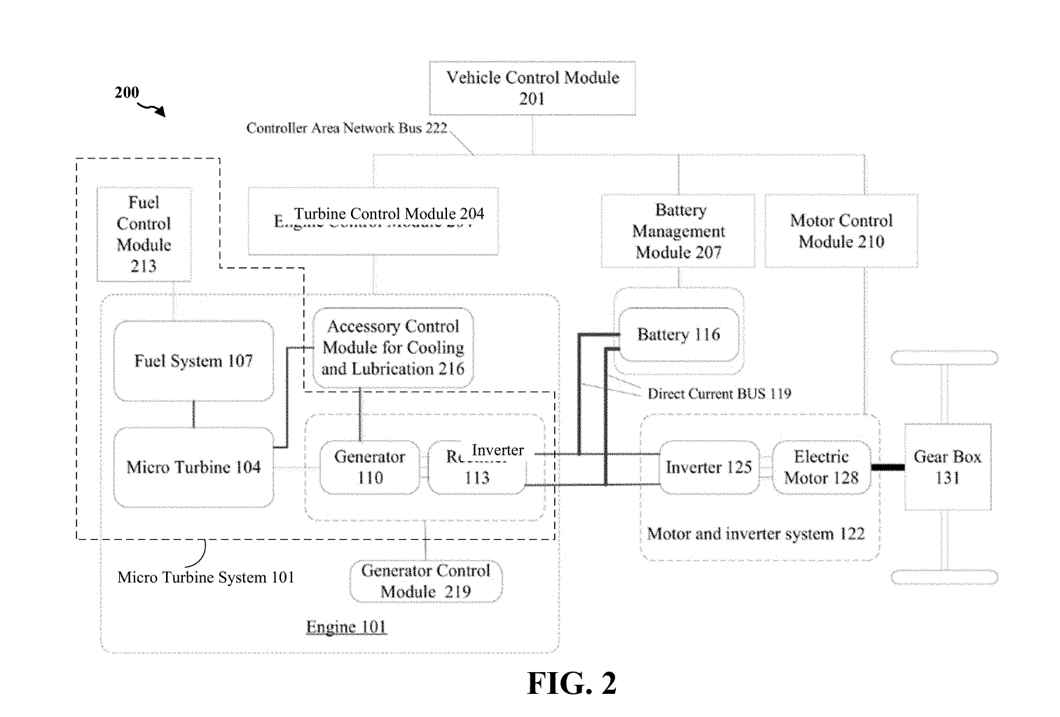

Fuel system 107 may supply compressed natural gas (CNG), diesel, gasoline, hydrogen, or other types of fuel to the micro turbine system 101 based upon the EREV fuel tank configuration. For example, the fuel system 107 may include a fuel tank (not shown) such as a gasoline tank, propane tank, gas tank, etc. to store fuel, hydrocarbon fuel, hydrogen, etc., which is supplied to micro turbine 104 under control of a fuel control module 213 (shown in FIG. 2). Micro turbine 104 can be configured to be compatible with high pressure natural gas, diesel fuels, high-pressure gaseous propane, hydrogen, unleaded gasoline, ethanol, methanol, ethane, methane, etc. Inverter 113 is an electrical device that converts AC to DC or DC to AC power. In one configuration, Inverter 113 rectifies the AC power from generator 110 to the DC power that can charge battery 116 and provide power to the Motor and Inverter System 122. Inverter 113 may be operated to transform the AC power to the DC power to provide power to the DC Bus 119, or DC to AC power to motor or starting the micro turbine 104.

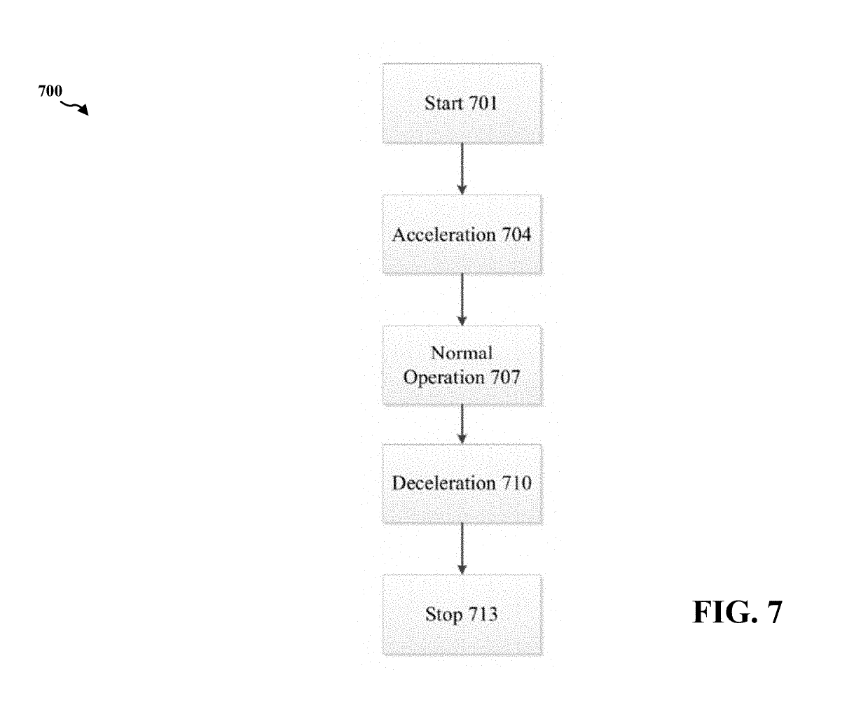

Battery 116 is connected to the outlet of inverter 113 through a DC bus 119 and is chargeable by an output of inverter 113. Battery 116 is disposed between inverter 113 and an inverter 125. Both inverter 113 and inverter 125 are bi-directional power controllers, which convert DC to AC or AC to DC power (Shown in FIG. 1 and FIG. 2). For the power system 100, the AC power from micro turbine 104 of micro turbine system 101 is the primary source for recharging the battery 116 and supplemental power to the electric motor 128. Specifically, the electricity for electric motor 128 is directly from battery 116 which may provide 100 percent, 95 percent, 90 percent, 85 percent, 80 percent, 75 percent, etc. of the power needed to drive electric motor 128, while generator 110 connected to micro turbine 104, inverter 113 and inverter 125 provides the remaining power to the DC bus 119 required by electric motor for a full operation of the EREV. In one configuration, the electricity from generator 110 may provide more than 50 percent of the power needed to drive electric motor 128, or any percentage of the power needed from more than 50 percent to 100 percent. Battery 116 may provide the remaining power through DC bus 119, inverter 125, to electric motor 128 so that electric motor has 100 percent of the power needed to drive electric motor 128. Operations of the EREV, including descriptions of the power adjustment for the EREV are described in FIG. 7. Micro Turbine System 101 may also provide local power source for electric motor 128 when an operation such as acceleration is performed. Further, when electric motor 128 is operated at a low speed, there is a reduced need for electrical power required to service electric motor 128, and then battery 116 may be used to store additional energy produced during the time of reduced load from micro turbine 104. Battery 116 may be a single battery or multiple batteries.

Motor and inverter system 122 includes inverter 125 and electric motor 128 connected to an outlet of inverter 125.

Inverter 125 is an electrical device that converts electricity derived from a DC source to an AC source that can be used to drive an AC appliance. Inverter 125 is connected to DC bus 119 and is used to convert the regulated voltage from DC bus 119 to an operating voltage for driving electric motor 128. In one configuration, inverter 125 transforms the DC power to the AC power, and the AC power is subsequently applied to electric motor 128 of the hybrid vehicle. Inverter 125 may output power at a variety of voltages for different load requirements of electric motor 128. For example, when the EREV is on a congested road, electric motor 128 may be provided with a lower power for operations of the EREV. In another configuration, when the EREV has a heavier payload, electric motor 128 may be provided with a higher power for operations of the EREV.

Electric motor 128 is an electrical machine that converts electrical energy into mechanical energy and is connected with, and drivable by, the power from inverter 125. A motor drive shaft extends from electric motor 128 and is in mechanical connection with gear box 131. Electric motor 128 may be used to rotate gear box 131.

FIG. 2 is a schematic diagram 200 illustrating a vehicle control module of an EREV. Vehicle control module 201 includes an overall control board with software that controls and manages vehicle powertrain system including micro turbine 104, battery 116, electric motor 128 and overall operations of system 100. Specifically, vehicle control module 201 includes a turbine control module 204 for controlling micro turbine system 101, a battery management module 207 and a motor control module 210. In one configuration, a controller area network (CAN) bus 222 may be utilized to allow microcontrollers and devices to communicate with each other without a host computer.

Turbine control module 204 provides overall electronic control with software that controls and manages operations and communications of micro turbine system 101 and sub-components. Specifically, turbine control module 204 includes fuel control module 213 that controls fuel supply to micro turbine system 101, an accessory control module for cooling and lubrication 216 of generator 110 and micro turbine 104, and a generator control module 219 that controls operations of generator 110 and inverter 113.

Battery management module 207 is an electronic system that manages battery operation such as monitoring operating state, reporting operation data, controlling battery operation environment, balancing cell voltage and preventing battery 116 from operating outside battery safe operating region. Specifically, battery management module 207 controls operation and management of battery 116. In one configuration, when an operation such as acceleration is performed, electric motor 128 needs extra power to perform the acceleration and battery management module 207 may control battery 116 to supply the extra DC bus 119 power to electric motor 128 through inverter 125. In another configuration, when there is excess power from micro turbine 104 and battery 116 needs to be recharged, battery management module may recharge battery 116 through DC bus 119.

Motor control module 210 is a power electronic system that controls operations of electric motor 128 including regulating and converting power from a DC to an AC power to control motor output power, torque and frequency (speed) based on driving input. Specifically, motor control module 210 controls operations of electric motor 128 and adjusts operation of inverter 125 accordingly.

Fuel control module 213 is an electronic control board that controls fuel delivery to micro turbine 104 from fuel system 107, which includes flow rate control, pressure control and flow distribution to an individual fuel injector through a fuel manifold within fuel system 107.

Accessory control module for cooling and lubrication 216 is a module that controls proper cooling to operate micro turbine system 101 within a safe temperature limit and sufficient lubrication to a bearing system to maintain a stable rotor dynamic system of micro turbine system 101.

Generator control module 219 is a power electronic module that manages the AC and DC power conversion between the generator 110 and inverter 113 respectively. In the conversion of DC power to an AC power to drive generator 110, initiates micro turbine 104 and/or a compressor 304 during an engine startup process, and/or converts an AC to a DC power during normal turbine operation to generate electricity. In one configuration, generator 110 may be a high speed permanent magnet generator 301.

FIG. 3 is a schematic diagram illustrating additional definition of micro turbine system 101. Micro turbine system 101 includes compressor 304 connected to permanent magnet generator 301 and is driven by permanent magnet generator 301, a lean premix combustor module 310, turbine wheel 355, recuperator 317, and fuel system 107.

Permanent magnet generator 301 includes a permanent magnet rotor or sleeve and a permanent magnet stator. Any other suitable type of motor generator may also be used. The permanent magnet rotor or sleeve may contain a permanent magnet. The permanent magnet rotor or sleeve and the permanent magnet disposed therein are rotatably supported within the permanent magnet generator stator. Preferably, one or more compliant foil, fluid film, radial, or journal bearings rotatably support the permanent magnet rotor or sleeve and the permanent magnet disposed therein. All bearings, thrust, radial or journal bearings may be fluid film bearings or compliant foil bearings. Permanent magnet generator 301 includes a housing that encloses stator heat exchanger having a plurality of radially extending stator cooling fins.

During operations of system 300, intake air 307 flows over the permanent magnet generator 301 and into compressor 304. The air that flows over the permanent magnet generator 301 flows into an annular space between the permanent magnet generator housing and the permanent magnet generator stator along a flow path. Heat can be exchanged from stator cooling fins to the air from intake air 307, thereby cooling the stator cooling fins, the stator and the rotor.

Compressor 304 compresses the intake air 307 from a low pressure to a high pressure. The compressed intake air will be delivered to a recuperator 317. Compressor 304 may include compressor impellers and compressor housing. The compressor impellers compress intake air 307 and force the compressed air of intake air 307 to flow into recuperator 317.

Recuperator 317 heats the compressed intake air and recovers waste heat of turbine exhaust air 320 from turbine wheel 355. Recuperator 317 may have an annular shape defined by cylindrical recuperator inner wall and cylindrical recuperator outer wall. Recuperator 317 includes a first set of passages connecting from compressor 304 to lean premix combustor module 310 and a second set of passages connecting from turbine exhaust air 320 to micro turbine exhaust air 323. In the first set of passages of recuperator 317, heat is exchanged from walls of recuperator 317 to the compressed intake air 307. The heated and compressed air flows out of recuperator 317 and flows into lean premix combustor module 310. Fuel (not shown) from fuel system 107 mixes with the heated and compressed air in lean premix combustor module 310, converting chemically stored energy to heat. Hot compressed gas mixture in lean premix combustor module 310 then flows through turbine wheel 355, forcing turbine wheel 355 to rotate.

Lean premix combustor module 310 may comprise one or more fuel injector inlets to accommodate fuel injectors which receive fuel from fuel system 107 and inject fuel or a fuel air mixture to interior of lean premix combustor module 310. Lean premix combustor module 310 mixes fuel or gas from fuel system 107 through the one or more fuel injectors with the heated and compressed intake air from recuperator 317. The mixture of the heated and compressed intake air from recuperator 317 and the fuel or gas combusts in a chamber of lean premix combustor module 310 and drives micro turbine 312 to operate in a high rotational speed. The lean pre-mix combustor module 310 and fuel system 107 are specifically configured to produce ultra-low emissions over a broad operating range of micro turbine system 101. A lean premixed combustor may operate in various states during operating conditions such as startup and shutdown, transient loads, steady state, and load following. Premixing significantly minimizes the formation of NOx, CO, PM, and NMHC to levels less than EU6 and CARB 2010 requirements without the need for micro turbine exhaust air 323 emissions after treatment.

Micro turbine 104 is a small combustion turbine that is suitable to be placed in a personal vehicle. Micro turbine 104 can be scaled to generate power outputs of 5 kW to 500 kW. Micro turbine 104 includes a turbine wheel 355. The hot and compressed mixture from lean premix combustor module 310 flows through turbine wheel 355 and forces the turbine wheel to rotate. Micro turbine 104 is designed so that exhaust gas flowing from lean premix combustor module 310 through turbine wheel 355 enters into a cylindrical passage and then moves in a direction to the second passage of recuperator 317. Turbine wheel 355 and compressor 304 may be mechanically coupled by bolts, or other suitable technique, to rotate when the turbine wheel 355 of micro turbine 104 rotates. A mechanical coupling connects the compressor 304 to the permanent magnet rotor shaft. The permanent magnet rotor shaft rotates when compressor 304 rotates.

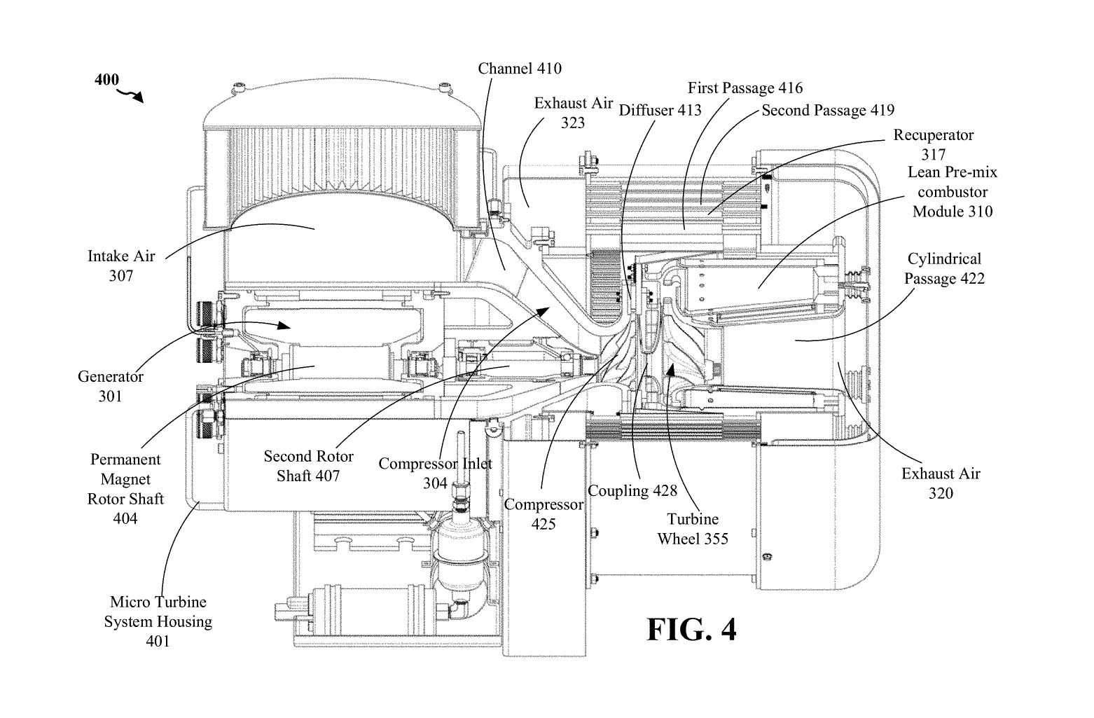

FIG. 4 is a sectional view of a micro turbine system 101 excluding fuel system 107. Micro turbine system 101 has a housing 401. Intake air 307 flows in a space between inner wall of housing 401 and outer wall of generator 301, and enters into compressor inlet 304. Generator 301 has a permanent magnet rotor shaft 404 and a second rotor shaft 407 mechanically coupled to permanent magnet rotor shaft 404. Compressor 425 is connected to the second rotor shaft 407. Compressor 425 is mechanically coupled to turbine wheel 355 through coupling 428. During startup of micro turbine system 101, generator 301 takes the DC power from battery 116 to rotate the couple rotor group comprising of the permanent magnet rotor shaft 404, compressor 425 and turbine wheel 355. Compressor 425 compresses intake air 307. The compressed air flows to a first passage 416 through diffuser 413 and may be heated by recuperator 317. The heated air from recuperator 317 flows to a chamber of lean premix combustor module 310. When the rotational speed of micro turbine 104 reaches a preset rotational speed, micro turbine 104 will ignite the fuel or gaseous supply from fuel system 107 to mix with heated air from recuperator 317 and the mixture starts the combustion process in lean premix combustor module 310 that produces ultra-low emissions. The combustion process converts chemical energy to kinetic energy through a gas expansion process to rotate turbine wheel 355 of micro turbine 104. The kinetic energy drives compressor 425 and permanent rotor shaft 404 to produce electricity through generator 301. Turbine exhaust air 320 flows to a cylindrical passage 422 and then flows to a second passage 419 of recuperator 317.

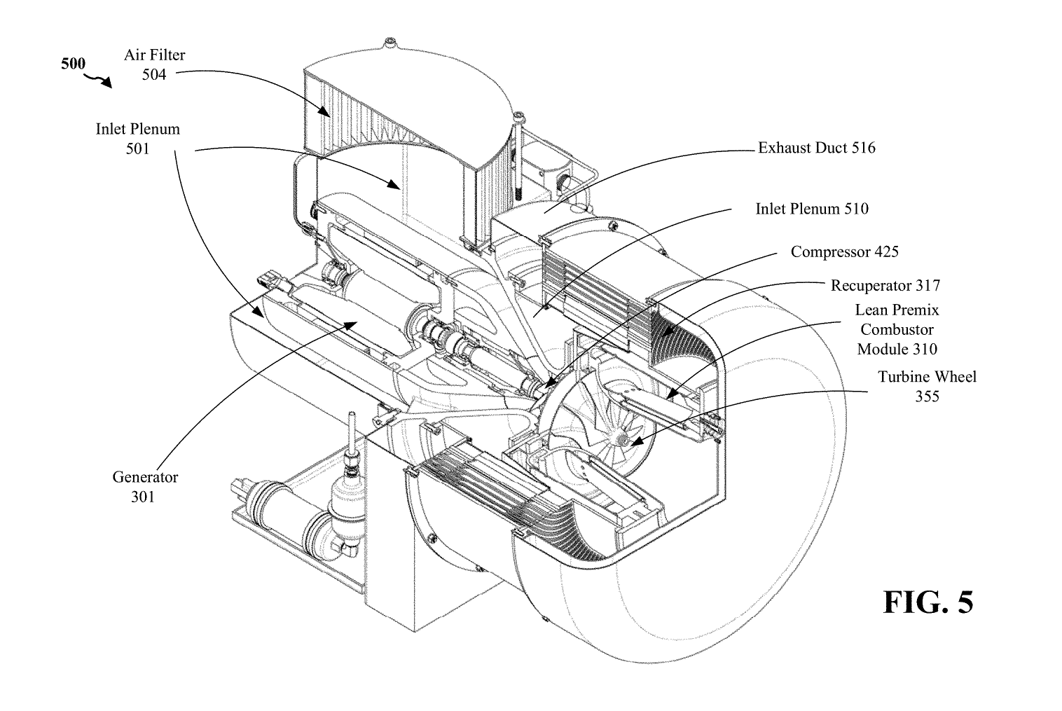

FIG. 5 shows another sectional view of micro turbine system 101. Intake air 307 goes through an air filter 504 and forms an inlet plenum 501 around the outer wall of generator 301. Compressed air after compressor 425 enters an inlet transition plenum 510 before entering recuperator 317. Compressor 425, turbine wheel 355 and permanent magnet rotor shaft 404 are mechanically coupled and rotate along a same axial axis. Exhaust air 320 from turbine wheel 355 goes through recuperator 317 and enters an exhaust duct 507 before micro turbine exhaust air 323 is released.

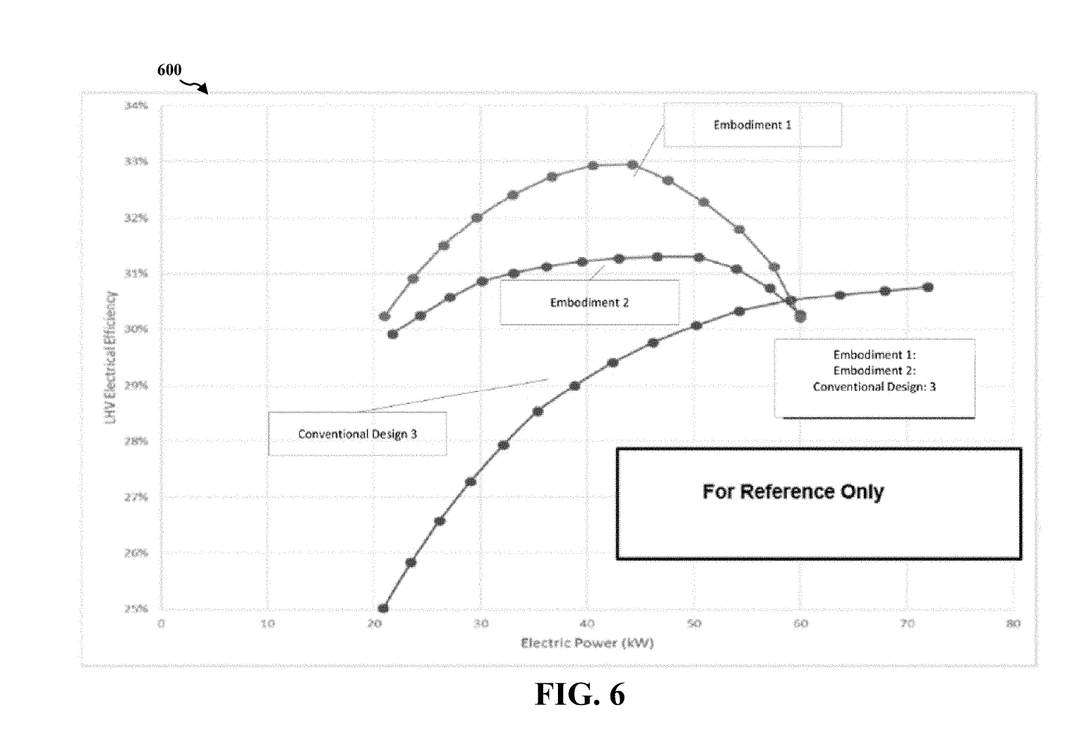

FIG. 6 shows a comparison of electrical efficiency of a conventional EREV not employing a micro turbine system and two exemplary EREVs employing the micro turbine system disclosed in the present disclosure. The two exemplary EREVs may have a lower heating value (LHV) electric efficiency from about 30 percent to about 33 percent when the electric power is from 20 kilowatts to 60 kilowatts, which is much higher than the efficiency of the conventional design.

FIG. 7 is a flow chart 700 illustrating operation procedures of an EREV. During start 701, a driver starts the EREV. Vehicle control module 201, including turbine control module 204, battery management module 207, motor control module 210, fuel control module 213, accessory control module for cooling and lubrication 216 and generator control model 219, checks the operation status of system 100 and its components. For example, battery management module 207 checks whether the EREV has a battery power higher than a predetermined power level. If the battery power is higher than the predetermined power level, the EREV will indicate an “OK” status for battery 116. Further, fuel control module 213 may check whether the EREV has an amount of fuel or gaseous supply in a fuel tank more than a predetermined level of fuel or gaseous supply. If the amount of fuel or gaseous supply in a fuel tank is more than the predetermined level of fuel or gaseous supply, fuel control module 213 may indicate an “OK” status for fuel or gaseous supply. Until vehicle control module 201 checks that the status of system 100 and its components is indicated as “OK” and the EREV is safe enough for driving, the EREV will start micro turbine system 101.

After startup of micro turbine system 101, for example, a speed sensor (not shown) detects the speed of the EREV. When the speed is lower than the speed required by the driver, vehicle control module 201 determines to start acceleration 704. If the battery management module 207 determines that battery 116 requires additional power to support acceleration 704, battery management module 207 will have turbine control module 204 control micro turbine system 101 to provide the required power to DC bus 119.

During acceleration 704, and prior to startup of micro turbine system 101, generator 301 takes the DC power from DC bus 119 to rotate permanent magnet rotor shaft 404, compressor 524, and turbine wheel 355. Specifically, DC bus 119 provides the power to generator 301 to rotate permanent magnet rotor shaft 404, compressor 425, and turbine wheel 355. Further, DC bus 119 provides power to inverter 125 and electric motor 128. After the rotational speed of micro turbine 104 reaches the preset rotational speed, turbine control module 204 may determine that micro turbine 104 may ignite the fuel or gaseous supply from fuel system 107 to mix with the heated air from recuperator 317. The combustion process converts chemical energy to kinetic energy through a gas expansion process to rotate turbine wheel 355 of micro turbine 104. The kinetic energy drives compressor 425 and permanent rotor shaft 404 to produce electricity through generator 301. Specifically, the electricity generated from the rotation of micro turbine 104 provides power to DC bus 119 for electric motor 128 for driving gear box 131. Battery 116 may stop the power supply to DC bus for electric motor 128. However, the EREV may still run at a speed lower than the operation speed required by the driver. The driver will press a throttle to request more fuel or gas supply. Fuel system 107 may determine to supply more fuel or gaseous supply in accordance with the required speed of the driver. As such, the combustion process converts more and more chemical energy to kinetic energy through a gas expansion process to rotate turbine wheel 355 of micro turbine 104 to produce more electricity through generator 301. The amount of electricity provided to electric motor 128, through inverter 113 and inverter 125, is increasing until the electricity provided to electric motor 128 is sufficient to drive gear box 131 at the speed required by the driver. In other words, acceleration 704 continues until the EREV reaches the speed required by the driver. In one configuration, during acceleration 704, battery 116 continues to supply the power to electric motor 128 until electric motor 128 drives gear box 131 at the speed required by the driver. In one configuration, vehicle control module 201 may draw as much electricity as possible from micro turbine 104 to satisfy the need of acceleration 704, while the remaining part of the “additional” electricity required for acceleration is provided by battery 116. Micro turbine system 101 is supplemental in nature. If all the additional electricity needed for acceleration can be supplied by battery 116, then micro turbine system 101 does not need to provide any electricity to electric motor 128.

During normal operation 707, the EREV runs at the speed required by the driver. micro turbine system 101 may provide no power to DC bus 119. All the power is provided from battery 116. In one configuration, the electricity provided by micro turbine 104 is higher than the power required by electric motor 128, and the electricity may be used to charge battery 116 when needed. In one configuration, fuel system 107 may maintain a constant fuel or gaseous supply to the EREV so that micro turbine 104 may provide 100 percent power required by the DC bus 119. In one configuration, inverter 125 may output the multi-phase AC power at a variety of voltages for electric motor 128. Power adjustment and power balance for the EREV between power sources of micro turbine 104 and battery 116 may be controlled by vehicle control module 201. However, during normal operation 707, battery 116 will provide the primary power source for electric motor 127. Specifically, the primary power is more than 50 percent of the power required by the EREV for operating at the full speed required by the driver. The primary power may be any percent from more than 50 percent to 100 percent of the power required by the EREV for operating at the full speed required by the driver. Also, the primary power may be more than 90 percent, 95 percent, or even more than 99 percent of the power required by the EREV. The battery 116 primary power may be supplemented by micro turbine system 101 depending upon the vehicle's driving condition.

During deceleration 710, the driver may either press the brake of the EREV, or adjust the throttle position, therefore reducing the electricity provide to the electric motor 128 in accordance with the required speed of the driver. The power needed for operating the brake and the fuel or gaseous supply panel may be provided by battery 116. In one configuration, fuel system 107 may still maintain a same fuel or gaseous supply to the EREV for deceleration 710 or normal operation 707, but the extra power from micro turbine system 101 may be used to charge battery 116 when needed. After the rotational speed of micro turbine 104 of micro turbine system 101 is lower than the preset rotational speed, micro turbine system 101 may not supply power to the DC bus 119.

During stop 713, the driver presses the brake and stops the EREV. The vehicle's braking system and electric motor 128 stops the EREV. During braking, electric motor 128 assists with slowing the vehicle down through regenerative braking. The regenerative braking provided by electric motor 128 provides electrical energy back to the battery 116, through the inverter 125 and DC bus 119. Turbine control module 204 may determine that fuel system 107 provides no fuel supply.

From a first normal operation to a second normal operation of the EREV, acceleration or deceleration may involve switching from the first normal operation to the second normal operation. However, acceleration or deceleration between the first normal operation and the second normal operation may be different from acceleration 704 or deceleration 710. For example, in the first normal operation, micro turbine 104 has already been initiated and is operating at a certain rotational speed, while micro turbine 104 may require additional fuel from fuel system 107 to deliver additional power to DC bus 119 acceleration 704, and in the second normal operation, micro turbine 104 may still run at a second rotational speed greater than a threshold but different from a first rotational speed while micro turbine 104 may approach to zero rotational speed during deceleration 710 and may provide a charge to battery 116 or no charge at all. Accordingly, from the first normal operation to the second normal operation of the EREV, the primary power for acceleration may not be necessarily from battery 116, and micro turbine 104 may provide the primary power to the DC bus 119 for switching between the first normal operation and the second normal operation of the EREV based upon battery 116 state of charger.

In one configuration, the size of battery 116 is smaller than that of a traditional EREV because battery 116 provides the secondary power and does not need to provide the primary power to the EREVs DC bus 119. Further, the requirements of charging and/or discharging battery 116 are not as strict as these of the traditional EREV. For example, it may take much longer time to charge and/or discharge battery 116 than the battery installed in the traditional EREV.

In one configuration, micro turbine system 101 has a rotating system that includes a coupled rotor assembly. The coupled rotor assembly is a generator rotor assembly and the other is a powerhead rotor assembly. The coupled rotor assembly are connected via a mechanical coupling that allows torque transmission between them without inducing rotor dynamic response and bearing loads. The powerhead rotor assemblies may have two configurations: 1) an overhung back-to-back compressor and a turbine wheel with two outboard bearing packs on a cold side of a core flow; and 2) a compressor and a turbine wheel outboard of internal bearing packs. The generator rotor assembly comprised of a permanent magnet and a shaft specially assembled to prevent the permanent magnet from disintegrating and/or fracturing at high rotating speed condition.

In one configuration, the generator stator has a water jacketed housing to prevent from overheating and to optimize performance over a wide range of vehicle operating conditions.

In one configuration, micro turbine system 101 includes a bearing cartridge for the generator rotor assembly and the powerhead rotor assembly. The bearing cartridge is designed to withstand high radial and thrust loads; capable of high cycle start and/or stop operations that are well suitable for vehicle applications; and includes a set of rolling element bearings and sleeves to set a rotor shaft for optimal rotor response and to provide damping when assembled in a housing.

In one configuration, the bearing housing includes a unique water jacked cooling system to prevent lubrication oil from coking and to prevent bearing from over-heating.

In one configuration, a special air intake device is designed to attenuate acoustic noise and minimize engine performance loss. Further, the system itself is designed to have a noise reduction architecture that decreases overall noise levels for the system.

In one configuration, lean premix combustor module 310 has an ignitor (not shown). Quick ignition capability for the ignitor is designed for minimizing startup pollution for high cycle operation. In another configuration, design and architecture of lean premixed injector provides an ultra-low emission combustion system for vehicle applications with fuel flexibility, operable over a wide operating range.

In one configuration, instrumentations such as emission sensors, dynamic pressure sensors, thermal couples, speed sensors, pressure transducers and proximity probes are employed to monitor combustion performance, stability and overall performance of micro turbine system 101.

In one configuration, the turbine efficiency is maximized and maintained by controlling turbine inlet temperature throughout the operating range from maximum to partial power conditions while monitoring with feedback signals from the instrumentations.

In one configuration, combustion performance such as emission and flame stability is controlled at its optimal operating region with the feedback signals from the instrumentations to meet the most stringent emission regulatory requirements.

In one configuration, combustion system is able to accommodate more fuel types with large fuel composition variations using active control methods.

In one configuration, the EREV is a plug in electric vehicle with a battery and an on-board automotive micro turbine generator (AMT) to charger the battery and/or provide power to the electric motors.

In one configuration, the EREV is directly and solely driven by the electric traction motors.

The power sources of the EREV come from the battery and the micro turbine, each of which can power the electric motor directly through the DC bus. The battery is the primary power source for vehicle transient operations such as acceleration, or energy storage when needed while the micro turbine serves as the supplemental power source. The micro turbine is the secondary or primary power source to and can also become the primary power source. If the micro turbine is the primary power source, a smaller capacity battery is required compared to a traditional EREV.

In one configuration, the system can be applied to different transportation tools such as a train, a ship, a truck, and so on. The present application is not limited to be applied to an electrified range extended vehicle.

The benefits of the present disclosure include, but are not limited to: a lower cost including a low initial cost and a low life cycle cost, and reduced weight which leads to higher vehicle efficiency.

The advantages of using the micro turbine as the primary power for the electric vehicle include, but are not limited to: fewer moving parts, compact in size, light weight, longer component life, potential for reuse, high thermal efficiency resulting in low fuel cost, potential to recover exhaust gas heat, ultra-low emissions, cleaner than grid & other combustion technologies, no expensive exhaust after treatment, capability of using multiple fuels including CNG, diesel, gasoline, hydrogen, no range anxiety and using existing fueling infrastructure.

Further, the electrified range extended vehicle has the on-board battery for energy storage and on-board micro turbine for power generation. The battery and micro turbine operate as an integrated system that can be configured to provide power to the grid. Certain implementations provide vehicle to grid power application via micro turbine or IC engine range extender technology with low emission. Certain implementations provide vehicle to vehicle grid network to support local high energy demand or during natural disaster. Certain implementations provide local power demand in off-grid and rural area without easy access to local utility. Certain implementations provide alternative clean power source based on local fuel availability due to system's fuel flexibility with a micro turbine system.

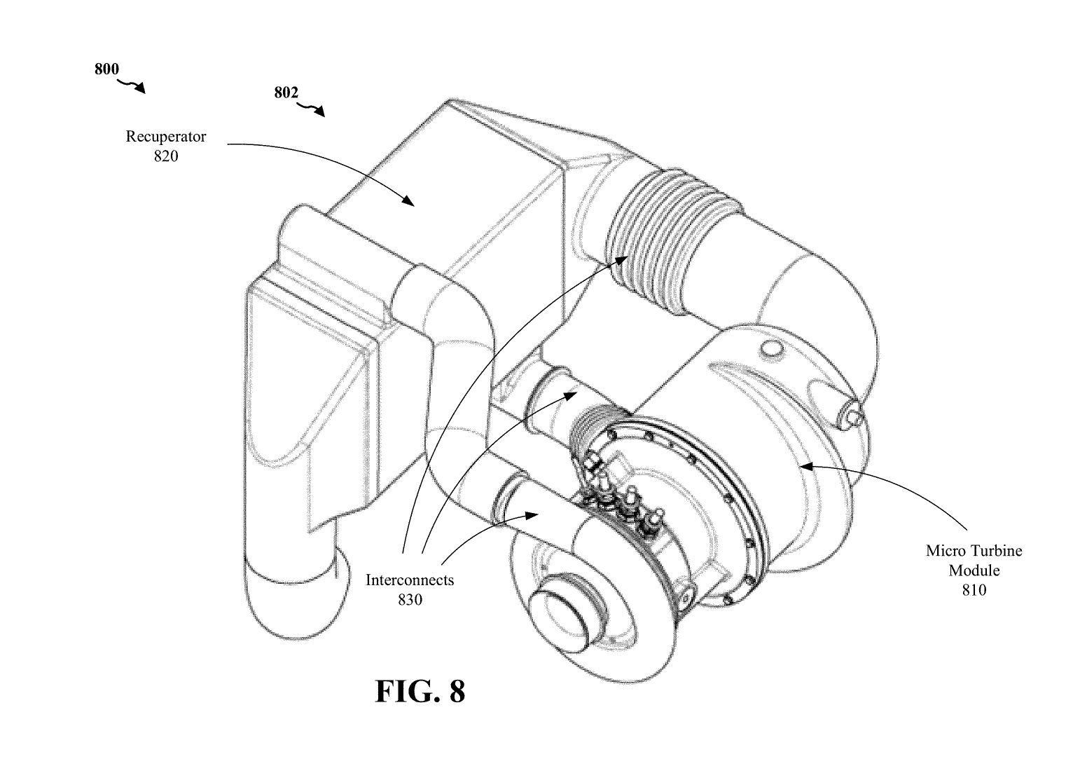

FIG. 8 is a diagram 800 illustrating another micro turbine system 802. The micro turbine system 802 includes, among other components, a micro turbine module 810, a recuperator 820, and interconnects 830. The micro turbine system 802 may be used for EREV applications. The micro turbine system 802 can generate electricity to recharge the vehicles batter pack(s), to power the e-motor drive, or to simultaneously recharge the vehicle battery packs and power the e-motor drive of an EREV. The micro turbine system 802 may be designed to provide variable power from 0 to a maximum power output. The maximum output is defined by the micro turbine's product application. As an example, the power range could be 0 to 60 kW, where the 60 kW is the maximum power output for the micro turbine. The micro turbine module 810, the recuperator 820, and the interconnects 830 can be sized to optimize power output and cycle efficiency. The micro turbine system 802 employs a modular design to optimize the micro turbine's performance.

In certain configurations, the micro turbine system 802 employs a modular plug and play design. The micro turbine module 810, the recuperator 820, and the interconnects 830 are interchangeable such that packaging/product integration into vehicles is flexible due to the modularity. Modules can be either assembled/packaged local to each other or different locations within the engine compartment to support vehicle design requirements.

Further, in certain configurations, the micro turbine system 802 can be operated as a non-recuperated unit (i.e., a Simple Cycle). The recuperator 820 is removed and the interconnects 830 are simplified to still facilitate the operation of the micro turbine system 802.

Given the modular design, serviceability is simplified compared to other existing automotive electrical range extender (power generation) technology(s) (e.g., micro turbine, ICE, fuel cell).

With the Module/Component interchangeability, the micro turbine system 802 can be integrated with other modules or components to support efficient power generation, ultra-low emissions, in the areas but not limited to Vehicular, Stationary, and Marine applications.

With the Modular/Open architecture of the micro turbine design, it simplifies instrumentation for health, performance, and service monitoring requirements of the micro turbine system 802.

In addition, the modular architecture of the micro turbine system 802 can be beneficial for mass production where modules and components can be manufactured and tested at different site locations and then assembled at a primary location.

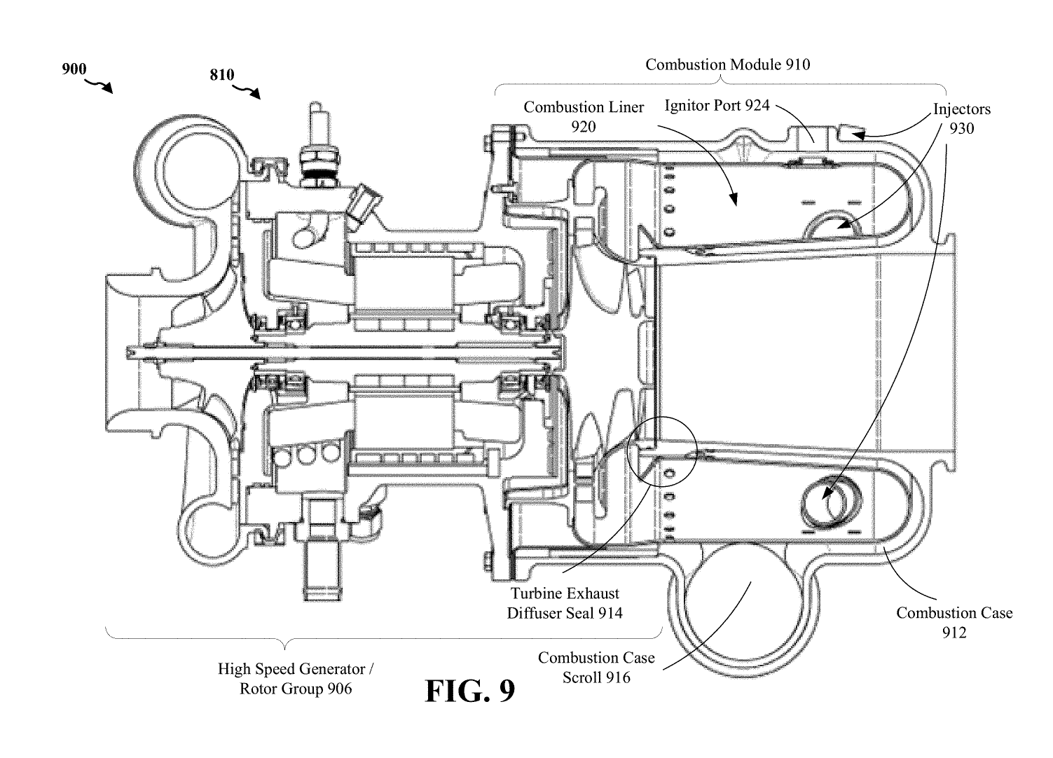

FIG. 9 is a diagram 900 illustrating the micro turbine module 810. The micro turbine module 810 includes a high speed generator/rotor group 906 and a combustion module 910. The combustion module 910 includes a combustion case 912, a turbine exhaust diffuser seal 914, a combustion case scroll 916, a combustion liner 920, an ignitor port 924, and injectors 930.

The combustion components (e.g., the injectors 930 and the combustion liner 920) are interchangeable that allows for the combustion of different fuel types such as gasoline, diesel, natural gas, and/or hydrogen. The combustion module 910 employs a compact injector design. The number of the injectors 930 for the micro turbine system 802 can range from 1 to M, which is the total number of injectors. M can be defined by the application and kW rating of the micro turbine system 802. As an example, 4 injectors could be a required number of injectors for a 60 kW micro turbine system.

The combustion module 910 has an integral design, which may yield ultralow emissions for different types of fuels. Such a design may result in lean pre-mix combustion technology, no exhaust after-treatment, wider operating range; 0 to full power (i.e. 60 kw), simplified fuel delivery and reliable light-off mechanism, optimized combustion through software and hardware controls to provide ultra-low emissions.

Further, the combustion case 912 with an integral combustion case scroll 916 may provide uniform compressor discharge flow into the combustion liner 920.

In addition, the entry angle of the injectors 930 into the combustion case 912 and the combustion liner 920 has a tangential and axial entry component to facilitate lean premix combustion process, to minimize flame impingement on the inner or outer sections of the combustion liner and adjacent injectors to facilitate optimized combustion gas mixing, and combustion gas residence time.

The combustion liner 920 may use floating seals to prevent contact stresses of the injectors 930 and/or the combustion liner 920 that can cause combustion liner distortion during thermal cycling of combustion module 910. The combustion liner 920 may also use floating seals to meter air flow by-pass between the body of the injectors 930 and the combustion liner 920 where the injector 930 penetrates into the combustion liner 920.

To maximize micro turbine performance throughout the range of the operation of microturbine system 802, minimize thermal stresses between combustion module 910 adjoining components, and prevent high pressure gas flow leakage across from the combustor into the turbine exhaust gas flow, the turbine exhaust diffuser seal 914 uses an axial/radial seal that permits thermal expansion and contraction between the turbine nozzle and the combustion case 912 throughout the range of the operation of the micro turbine system 802.

The high speed generator/rotor group 906 employs a liquid cooled high speed PM AC Generator, an intrinsically stable high speed rotating system architecture, a rotating system with centralized balanced generator architecture, an integrated turbo/generator rotor-group with ultra-low vibration, a high volume mass production single shaft two bearing rotor group design, a tie bolt conical nut to minimize the imbalance and stabilize the rotating group, and a light weight compact rotor group design that can be sized with respect to maximum generator kW output requirements, which further simplifies the micro turbine modular design architecture and uses a fast response rotor group design for rapid start/stop with high acceleration and deceleration rates.

The high speed generator/rotor group 906 is designed to work with a multi-purpose high efficient/high efficiency inverter controller and power electronics.

The architecture of the micro turbine system 802 may be built with integrated safety mechanisms for safe shut-down in the event there is a vehicle crash or vehicle system fault. The micro turbine system 802 may employ multiple mechanical and control protection mechanisms such as over speed, over current/voltage, over temp, fuel shutoff, etc.

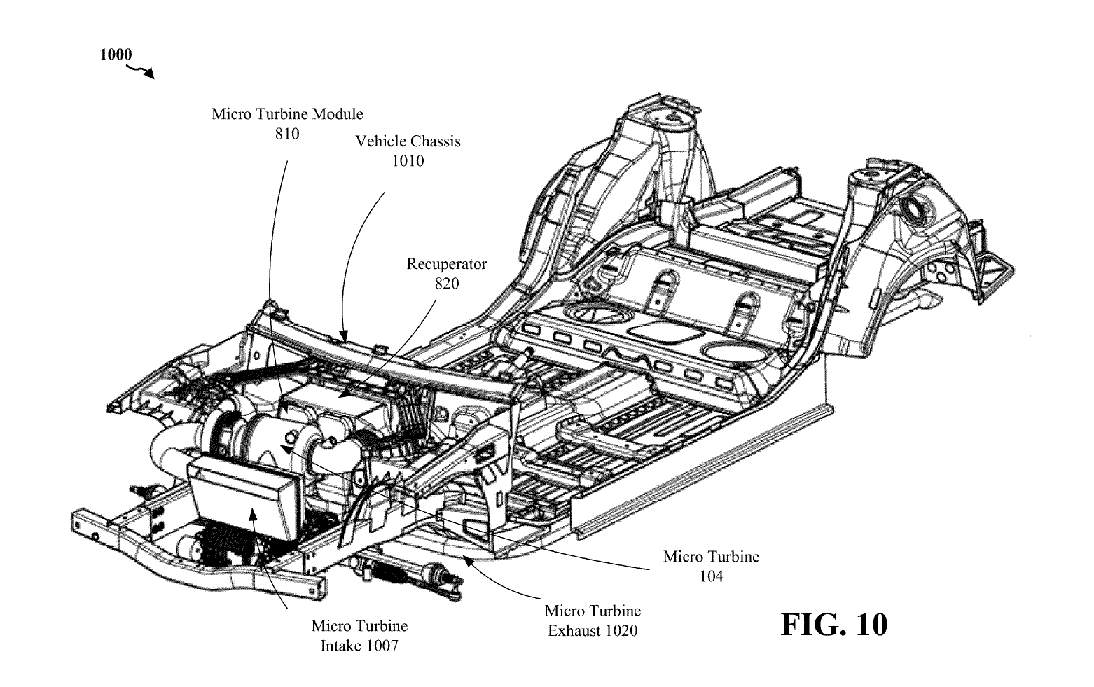

FIG. 10 is a diagram 1000 illustrating a vehicle chassis 1010 incorporating the micro turbine system 802. The micro turbine system 802 can easily be mounted on a sub-frame that will integrate to a vehicle's chassis. The micro turbine system 802 includes a micro turbine module 810, which contains, among other components, the micro turbine 104, the micro turbine intake 1007, a micro turbine exhaust 1020, and the recuperator 820.

The foregoing description of the exemplary configurations of the present disclosure has been presented only for the purposes of illustration and description and is not intended to be exhaustive or to limit the present disclosure to the precise forms disclosed. Many modifications and variations are possible in light of the above teaching.

The configurations are chosen and described in order to explain the principles of the present disclosure and their practical application so as to activate others skilled in the art to utilize the present disclosure and various configurations and with various modifications as are suited to the particular use contemplated. Alternative configurations will become apparent to those skilled in the art to which the present disclosure pertains without departing from its spirit and scope. Accordingly, the scope of the present disclosure is defined by the appended claims rather than the foregoing description and the exemplary configurations described therein.

What is claimed is:

1. A vehicle power system, comprising:
an electric motor;
a primary power source that energizes the electric motor, wherein the primary power source employs a battery to provide electricity through a DC bus;
a second power source that supplements the primary power source to energize the electric motor, where the second power source employs a micro turbine; and
a control component that monitors power provided to the electric motor by the primary power source, that determines that additional power needs to be provided to the electric motor in order to meet a driving requirement, and that directs additional power from the second power source to the electric motor and/or battery through a DC bus.

2. The vehicle power system of claim 1, wherein the control component is configured to:
determine that the electric motor needs a first amount of power to meet a driving requirement;
determine that the second power source generates a primary amount of power that is greater than the first amount;
direct the first amount of power from the primary power source to the electric motor; and
direct power from the second power source other than the first amount to the primary power source to charge the primary power source through a DC bus.

3. The vehicle power system of claim 1, wherein the control component is configured to:
determine that the electric motor needs a first amount of power to meet a driving requirement;
determine that the second power source generates a primary amount of power that is smaller than the first amount;
direct the second amount of power from the primary power source to the electric motor; and
direct power from the second power source to the electric motor such that the electric motor receives the first amount of power.

4. The vehicle power system of claim 3, wherein the first amount is greater than 50% of the second amount.

5. The vehicle power system of claim 1, wherein the control component is configured to:
determine that the electric motor needs a first amount of power to meet a driving requirement;
determine that a second amount of power generated by the primary power source when the turbine operates at a lowest preset rotational speed is greater than the first amount; and
energize the electric motor by power provided by the second power source without power provided by the primary power source.

6. The vehicle power system of claim 1, wherein the secondary power source further comprises a permanent magnet generator, wherein the control component is configured to:
during a startup of the secondary power source, directs power from the primary power source to the secondary power source's permanent magnet generator.

7. The vehicle power system of claim 1, wherein the secondary power source further comprises:
a recuperator that is configured to
absorb heat from exhaust air that is received from the turbine,
heat intake air that is received from a compressor, and
output the heated intake air to the combustor.

8. A method of operating a vehicle power system, comprising:
monitoring power provided to an electric motor by a secondary power source of the vehicle power system, wherein the secondary power source energizes the electric motor and/or battery through the DC bus, wherein the secondary power source employs a micro turbine to generate electricity;
determining that additional power needs to be provided to the electric motor in order to meet a driving requirement; and
directing the additional power from a second power source to the electric motor, wherein the second power source that supplements the primary power source to energize the electric motor and/or battery through the DC bus.

9. The method of claim 8, further comprising:
determining that the electric motor needs a first amount of power to meet a driving requirement;
determining that the primary power source generates a second amount of power that is greater than the first amount;
directing the first amount of power from the primary power source to the electric motor; and
directing power from the secondary power source other than the first amount to the primary power source to charge the primary power source.

10. The method of claim 8, further comprising:
determining that the electric motor needs a first amount of power to meet a driving requirement;
determining that the primary power source produces a second amount of power that is smaller than the first amount;
directing the second amount of power from the primary power source to the electric motor; and
directing power from the second power source to the electric motor such that the electric motor receives the first amount of power.

11. The method of claim 10, wherein the first amount is greater than 50% of the second amount.

12. The method of claim 8, further comprising:
determining that the electric motor needs a first amount of power to meet a driving requirement;
determining that a second amount of power generated by the primary power source when the turbine operates at a lowest preset rotational speed is greater than the first amount; and
energizing the electric motor by power provided by the second power source without power provided by the primary power source.

13. The method of claim 8, wherein the secondary power source further comprises a permanent magnet generator, wherein the method further comprises:
during a startup of the secondary power source, directing power from the primary power source to the permanent magnet generator through the DC bus.

14. The method of claim 8, wherein the secondary power source further comprises a recuperator, wherein the method further comprises:
absorbing, at the recuperator, heat from exhaust air that is received from the turbine,
heating, at the recuperator, intake air that is received from a compressor, and
output, from the recuperator, the heated intake air to the combustor.

15. A computer-readable medium storing computer executable code for operating a vehicle power system, comprising code to:
monitor power provided to an electric motor by a primary power source of the vehicle power system, wherein the primary power source energizes the electric motor, wherein the primary power source employs a battery to provide electricity;
determine that additional power needs to be provided to the electric motor in order to meet a driving requirement; and
direct the additional power from a second power source to the electric motor, wherein the second power source employs a micro turbine that supplements the primary power source to energize the electric motor through the DC bus.

16. The computer-readable medium of claim 15, wherein the code is further configured to:
determine that the electric motor needs a first amount of power to meet a driving requirement;
determine that the secondary power source generates a second amount of power that is greater than the first amount;
direct the first amount of power from the secondary power source to the electric motor; and
direct power from the secondary power source other than the first amount to the primary power source to charge the second power source.

17. The computer-readable medium of claim 15, wherein the code is further configured to:
determine that the electric motor needs a first amount of power to meet a driving requirement;
determine that the primary power source generates a second amount of power that is smaller than the first amount;
direct the second amount of power from the primary power source to the electric motor; and
direct power from the second power source to the electric motor such that the electric motor receives the first amount of power.

18. The computer-readable medium of claim 17, wherein the first amount is greater than 50% of the second amount.

19. The computer-readable medium of claim 15, wherein the code is further configured to:
determine that the electric motor needs a first amount of power to meet a driving requirement;
determine that a second amount of power generated by the secondary power source when the micro turbine operates at a lowest preset rotational speed is greater than the first amount; and
energize the electric motor by power provided by the primary power source without power provided by the secondary power source.

20. The computer-readable medium of claim 15, wherein the secondary power source further comprises a permanent magnet generator, wherein the code is further configured to:
during a startup of the secondary power source, direct power from the primary power source to the permanent magnet generator through the DC bus.
